(19) United States
(12) Patent Application Publication
(10) Pub. No.: US 2007/0297634 A1
(43) Pub. Date: Dec. 27, 2007

(54) EARPHONE SYSTEM WITH USAGE DETECTION

(75) Inventor: Magnus Hansson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 11/426,610

(22) Filed: Jun. 27, 2006

(51) Int. Cl. H04R 25/00; H04R 1/10

(52) U.S. Cl. 381/384; 381/74; 381/380

(57) ABSTRACT

The invention relates to an earphone system with usage detection for controlling the routing of sound signals to an earphone or to a host device. The acoustic load on the earphone is detected and determines if the earphone is in a listening position at the ear of a user or not. The routing of the sound signals is based on the listening position of the earphone. If the earphone is in a listening position, the sounds are routed to the earphone, whereas if the earphone is not in a listening position, the sounds are routed to the host device.

### FIELD OF THE INVENTION

The present invention relates to an earphone system with usage detection for controlling the routing of sound signals to an earphone or to a host device. The acoustic load on the earphone is detected and determines if the earphone is in a listening position at the ear of a user or not.

### BACKGROUND OF THE INVENTION

Many portable devices for providing audio use earphones to provide the user with a possibility to use the device in a way that is silent to the environment and, particularly for mobile telephones, to provide a handsfree possibility. However, with mobile telephones users often remove the earphone from the ear when they are not using the audio player or engaged in a telephone conversation, because of the inconvenience of having the earphone in the ear and also because they may want to listen to surrounding sounds.

Most current telephones are adapted to route sound signals to the earphone as soon as the earphone is connected to the phone, based on the physical connector attached to the phone. They cannot detect if the earphone is worn or not. If connected but not worn, any sound signals intended for the user will then be missed, if they are sent to the earphone only.

On the other hand, some signals such as alert and notification sounds, are often output through the telephones sound system and not through the earphone, even when the earphone is connected. In that case, sound signals output through the phone's speaker system may be missed too, and also the sounds may disturb other persons in the vicinity, for instance if the user is in a meeting or in a public place.

US 20060/0,045,304 discloses a smart earphone connected to a host device, such as a music player or a cell phone. The listening position of the earphone is detected and the detected state is used to cause the host device to perform different operations such as turn on, turn off, play, pause, stop, answer call, end call etc.

An object of the present invention is to provide an earphone system with automatic routing of the electrical sound signals based on the listening position of the earphone.

Another object of the invention is to provide an earphone system with automatic adaptation of the frequency response of the earphone based on the listening position of the earphone.

In a first aspect, the invention provides an earphone system, comprising:

an earphone having a housing shaped and configured to be placed against an ear of a user, the housing containing a speaker module for converting electrical sound signals to acoustic sounds directed to the ear;
amplifier means for receiving sound information signals and producing the electrical sound signals to the earphone;
a control unit, wherein the control unit is adapted to detect whether the earphone is in a listening position against an ear of a user and to control the amplifier means in dependence of the listening position.

Suitably, the listening position is detected by measuring the electrical impedance of the speaker module.

The electrical impedance may be measured by measuring the actual voltage across terminals of the speaker module compared to the input signal level before the amplifier means.

In one embodiment, the control unit is adapted to control the frequency response of the amplifier means in dependence of the listening position and the listening position may vary from fully inserted through partly inserted to not inserted at all.

Suitably, the electrical impedance is measured as a function of frequency.

In a further embodiment, the amplifier means is adapted to receive sound information signals form a host device comprising a sound source and a speaker system, and the control unit is adapted to direct the sound signals to the speaker module, when the earphone is in a listening position, and to direct the sound signals to the speaker system of the host device, when the earphone is not in a listening position.

Suitably, the listening position is detected by measuring the electrical impedance of the speaker module.

The electrical impedance may be measured by measuring the actual voltage across terminals of the speaker module compared to the input signal level before the amplifier means.

In a still further embodiment, the earphone system comprises a pair of earphones, wherein the control unit is adapted to detect whether each earphone is in a listening position against an ear of a user, and the pair of earphones is deemed to be in a listening position when at least one of the earphones is in a listening position.

In a second aspect, the invention provides an earphone system, comprising:

an earphone having a housing shaped and configured to be placed against an ear of a user, the housing containing a speaker module for converting sound signals to sounds directed to the ear, and the speaker module being connectable to a host device;
said host device comprising:
a sound source, a speaker system, amplifier means for receiving sound information signals from the sound source and producing the sound signals;
a control unit, wherein the control unit is adapted to detect whether the earphone is in a listening position against an ear of a user and to control the amplifier means in dependence of the listening position.

Suitably, the listening position is detected by measuring the electrical impedance of the speaker module.

The electrical impedance may be measured by measuring the actual voltage across terminals of the speaker module compared to the input signal level before the amplifier means.

In one embodiment, the control unit is adapted to control the frequency response of the amplifier means in dependence of the listening position and the listening position may vary from fully inserted through partly inserted to not inserted at all.

Suitably, the electrical impedance is measured as a function of frequency.

In a further embodiment, the control unit is adapted to direct the sound signals to the speaker module of the earphone, when the earphone is in a listening position, and to direct the sound signals to the speaker system, when the earphone is not in a listening position.

Suitably, the listening position is detected by measuring the electrical impedance of the speaker module.

The electrical impedance may be measured by measuring the actual voltage across terminals of the speaker module compared to the input signal level before the amplifier means.

In a still further embodiment, the earphone system comprises a pair of earphones, wherein the control unit is adapted to detect whether each earphone is in a listening position against an ear of a user, and the pair of earphones is deemed to be in a listening position when at least one of the earphones is in a listening position.

The host device may be a mobile telephone, a pager, a communicator, a smart phone, an electronic organiser, or an audio player.

### BRIEF DESCRIPTION OF THE DRAWINGS

The invention will be described in detail below with reference to the accompanying drawings of which:

FIG. 1 is a side view of an earphone of the earbud type,

FIG. 2 is a schematic view of a headset unit according to one embodiment of the present invention, and

FIG. 3 is a schematic view of a host device for use in an earphone system according to the invention.

### DETAILED DESCRIPTION OF PREFERRED EMBODIMENTS

The invention relates to an earphone system for use with a sound sources located in a host device. The host device may be a mobile telephone a pager, a communicator, a smart phone, an electronic organiser or an audio player. The invention is perhaps most useful in a telephone or similar device, because of users' habit of connecting the earphone to the phone but not inserting the earphone in the ear. When the user then receives a telephone call or wants to listen to music he inserts the earphone in the ear. Until the earphone is inserted, no sound signals should be directed to the earphone.

On the other hand, the user wants to hear all sound signals through the earphone when it is inserted. If the user for example is in a meeting, he does not want any signals output through the phone's own speaker system.

The basic idea of the invention is to detect the earphone's listening position to control the routing of the electrical sound signals either to the earphone or to the speaker system of the host device. The listening position is detected by measuring the electric impedance of the speaker element of the earphone. As is known, the acoustic load on the speaker element varies considerably, if the earbud plays in the open air or into the small enclosed volume of an ear canal. When the earphone is positioned in the ear, the impedance of the acoustic load is increased and the electrical impedance of the speaker element is decreased. When the earphone is not inserted and in the open air, the impedance of the acoustic load on the speaker element is decreased and the electrical impedance of the speaker element is increased.

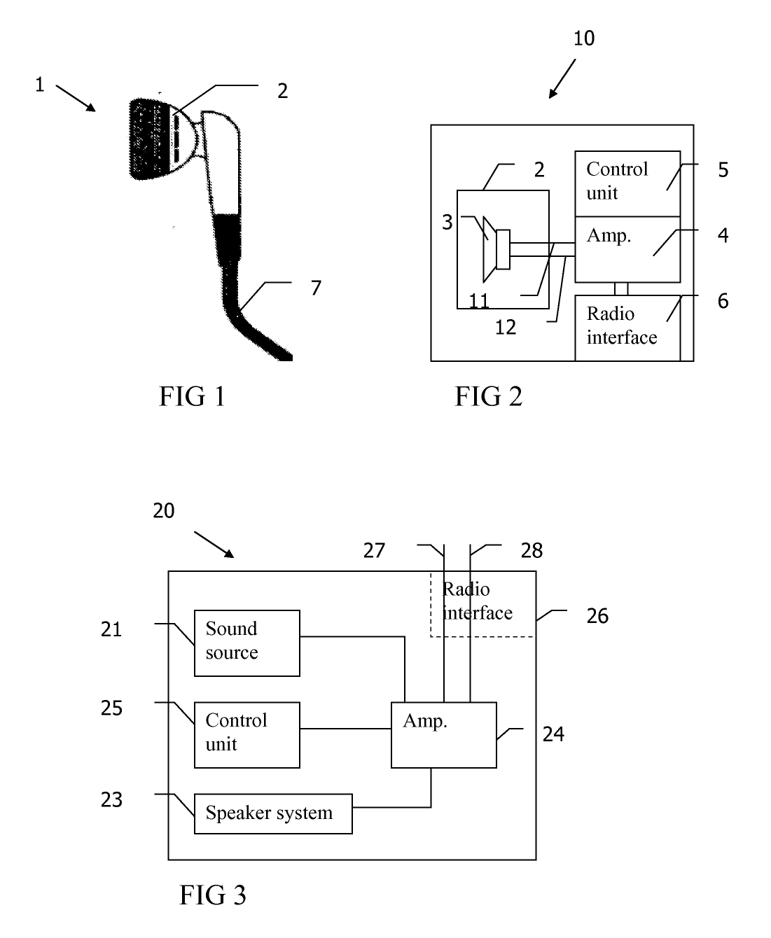

The change of acoustic impedance is most clearly manifested in earphones of the closed type, such as the model shown in FIG. 1, but also in earphones with some leakage and even of the open type placed against the outer ear, the change may be detected.

One embodiment of the invention is incorporated in a headset. The headset may comprise an earphone 1 as shown in FIG. 1. The earphone 1 has a housing 2 accommodating a speaker element. The housing 2 fits as a plug in the outer ear of a listener. The earphone may have padding so that the earphone may rest in the outer ear in close contact with the ear canal. In this position the earphone more or less seals off the ear canal resulting in a high acoustic impedance and low electrical impedance.

The earphone is connected by means of a cable 7 to a unit containing an amplifier 4, a control unit 5 and a radio interface 6. The radio interface is provided for communication with a radio interface 26 of a host device 20 as shown in FIG. 3.

The housing 2 and the speaker module 3 may be integrated in the same shell as indicated in FIG. 2. As is known, there may be two earphones connected, one for the left ear and one for the right ear of the user.

The headset 10 is connected to a host device 20 containing a sound source 21, an amplifier 24, a control unit 25 and a speaker system 23. A radio interface 26 is provided for communication with the headset 10. Alternatively, the headset may be connected by a cable with leads with at least one pair of +/− leads 27, 28.

The sound source 21 may be a telephone part of the host device or a music player etc. In the normal mode when the earphone 1 is inserted in the ear of a user, the sound signals produced by the sound source are transmitted through the radio interface 26 to the headset 10.

The listening position of the earphone is detected by the control unit 5. Preferably, the varying acoustic impedance of the speaker module 3 is exploited by measuring the voltage across the feeding +/− leads 11, 12 to the speaker module 3. The impedance can be calculated by measuring the actual voltage across the speaker module 3 and comparing it to the input signal level before the amplifier 4. Voltage detection circuits are known in the art, e.g. comprising A/D converters used today to detect various states in mobile telephones.

If the earphone is in the listening position, all sounds should be routed to the earphone speaker module 3. The control unit 5 communicates with the control unit 25 of the host device 20. If the host device 20 for example is telephone, all sounds in addition to speech of a conversation and music from an audio player, notification and warning signals including alarms, SMS and calendar alerts etc are directed to the earphone speaker module 3.

If the earphone is not in the listening position the control unit 5 notifies the control unit 25, so that sounds instead are directed to the speaker system 23 of the host device. This speaker system 23 produces sounds that are audible to the user through the open air. (The host device 20 may be in a silent mode for other reasons not related to the present invention.)

In another embodiment of the present invention, the earphone system comprises an earphone 1 with a speaker module only and connected by a cable 7 to the host device, such as host device 20 in FIG. 3. There is no control unit in the earphone, but the control unit 25 of the host device controls all operations. Similarly to the headset, there may be two earphones, one for the left ear and one for the right ear.

The operation of this embodiment is similar to the embodiment described above. The listening position of the earphone is detected by the control unit 25. In this case the voltage across the speaker module of the earphone 1 is measured across the terminals at the amplifier 24. The control unit 25 routes the sound signals either to the earphone 1, when it is in the listening position at the ear of a user, or to the speaker system 23 of the host device 20, when it is not.

As is mentioned above, both embodiments may comprise two earphones, one for each ear for stereophonic music or listening. Each earphone has its own pair of +/− leads. The respective control unit 5 or 25 is adapted to detect to the listening position of both of the earphones. When either of the earphones or both are in the listening position, all sounds are routed to the earphones and the host device 20 is silent. Only when both earphones are not in the listening position, sounds are routed to the host device 20 and its speaker system 23.

In a still further embodiment, the respective control unit 5 or 25 is adapted to detect a partly applied inserted earphone 1. The acoustic and electric impedance will vary depending on how well each user manages the earphone to seal off the ear canal. This in turn indicates which loudness and frequency response the user will experience. This information is used to compensate the frequency response and loudness of the audio signal going to the speaker module. The electric impedance is measured as a function of frequency and the frequency response of the amplifier 4 or 24 is adjusted to a suitable compensation. The listening position may vary from fully inserted through partly inserted to not inserted at all. In turn, the frequency response is adapted when the earphone is fully inserted or partly inserted, but sounds are routed to the host device 20 and its speaker system 23 when the earphone is deemed to be not inserted at all.

The invention has been described with a certain degree of particularity, but modifications and variations may occur to persons skilled in the art. The scope of the invention is only limited by the claims below.

1. An earphone system, comprising:
an earphone having a housing shaped and configured to be placed against an ear of a user, the housing containing a speaker module for converting electrical sound signals to acoustic sounds directed to the ear;
amplifier means for receiving sound information signals and producing the electric sound signals to the earphone;
a control unit, wherein the control unit is adapted to detect whether the earphone is in a listening position against an ear of a user and to control the amplifier means in dependence of the listening position.

2. An earphone system according to claim 1, wherein the listening position is detected by measuring the electrical impedance of the speaker module.

3. An earphone system according to claim 2, wherein the electrical impedance is measured by measuring the actual voltage across terminals of the speaker module compared to the input signal level before the amplifier means.

4. An earphone system according to claim 3, wherein the control unit is adapted to control the frequency response of the amplifier means in dependence of the listening position and the listening position may vary from fully inserted through partly inserted to not inserted at all.

5. An earphone system according to claim 4, wherein the electrical impedance is measured as a function of frequency.

6. An earphone system according to claim 1, wherein the amplifier means is adapted to receive sound information signals form a host device comprising a sound source and a speaker system, and wherein the control unit is adapted to direct the electrical sound signals to the speaker module, when the earphone is in a listening position, and to direct the electrical sound signals to the speaker system of the host device, when the earphone is not in a listening position.

7. An earphone system according to claim 6, wherein the listening position is detected by measuring the electrical impedance of the speaker module.

8. An earphone system according to claim 7, wherein the electrical impedance is measured by measuring the actual voltage across terminals of the speaker module compared to the input signal level before the amplifier means.

9. An earphone system according to claim 6, further comprising a pair of earphones, wherein the control unit is adapted to detect whether each earphone is in a listening position against an ear of a user, and the pair of earphones is deemed to be in a listening position when at least one of the earphones is in a listening position.

10. An earphone system, comprising:
an earphone having a housing shaped and configured to be placed against an ear of a user, the housing containing a speaker module for converting electrical sound signals to acoustic sounds directed to the ear, and the speaker module being connectable to a host device;
said host device comprising:
a sound source, a speaker system, amplifier means for receiving sound information signals from the sound source and producing the sound signals;
a control unit, wherein the control unit is adapted to detect whether the earphone is in a listening position against an ear of a user and to control the amplifier means in dependence of the listening position.

11. An earphone system according to claim 10, wherein the listening position is detected by measuring the electrical impedance of the speaker module.

12. An earphone system according to claim 11, wherein the electrical impedance is measured by measuring the actual voltage across terminals of the speaker module compared to the input signal level before the amplifier means.

13. An earphone system according to claim 12, wherein the control unit is adapted to control the frequency response of the amplifier means in dependence of the listening position and the listening position may vary from fully inserted through partly inserted to not inserted at all.

14. An earphone system according to claim 13, wherein the electrical impedance is measured as a function of frequency.

15. An earphone system according to claim 10, wherein the control unit is adapted to direct the electrical sound signals to the speaker module of the earphone, when the earphone is in a listening position, and to direct the electrical sound signals to the speaker system, when the earphone is not in a listening position.

16. An earphone system according to claim 16, wherein the listening position is detected by measuring the electrical impedance of the speaker module.

17. An earphone system according to claim 16, wherein the electrical impedance is measured by measuring the actual voltage across terminals of the speaker module compared to the input signal level before the amplifier means.

18. An earphone system according to claim 15, further comprising a pair of earphones, wherein the control unit is adapted to detect whether each earphone is in a listening position against an ear of a user, and the pair of earphones is deemed to be in a listening position when at least one of the earphones is in a listening position.

19. An earphone system according to claim 10, wherein the host device is a mobile telephone, a pager, a communicator, a smart phone, an electronic organiser, or an audio player.
